(19) United States
(12) Patent Application Publication
(10) Pub. No.: US 2020/0369537 A1
(43) Pub. Date: Nov. 26, 2020

(54) WATER HARDNESS STABILIZATION WITH ANION EXCHANGER

(71) Applicant: AQUIS WASSER-LUFT-SYSTEME GMBH, LINDAU, ZWEIGNIEDERLASSUNG REBSTEIN, CH-9445 Rebstein (CH)

(72) Inventor: Bernd HEITELE, CH-9437 Marbach (CH)

(21) Appl. No.: 16/968,529

(22) PCT Filed: Feb. 5, 2019
(86) PCT No.: PCT/EP2019/052686

§ 371 Date: Aug. 7, 2020

(30) Foreign Application Priority Data
Feb. 9, 2018 (DE) 10 2018 103 004.5

(51) Int. Cl. C02F 1/42; B01J 41/14; C02F 1/00; C02F 5/08

(52) U.S. Cl. CPC C02F 1/42; B01J 41/14; C02F 1/003; C02F 2103/02; C02F 2001/422; C02F 2201/006; C02F 5/086

(57) ABSTRACT

The invention relates to a solid dosing agent for dosing phosphate and/or polyphosphate in water. This is characterized by the provision of a water-insoluble anion exchanger that is at least partially loaded with orthophosphate and/or polyphosphate counterions.

This achieves both long-lasting stable storage of the polyphosphate and good dosing of polyphosphate in water.

The invention relates to a solid dosing agent and to a process for the production thereof and use thereof for dosing phosphate and/or polyphosphate in water as claimed in claims 1, 5, and 7.

For the protection of health, pipework, storage units, equipment, etc., water is generally treated before use by means of commercially available water filter cartridges. A key aspect thereof is controlling and/or preventing the formation of limescale.

This can include, firstly, the removal of hardeners from the water, for example by means of cation exchangers. In this process, calcium and magnesium ions are, for example, exchanged for sodium ions.

A second possibility is the inhibition of crystallization, i.e. the stabilization of hardness through the addition of inhibitors, for example polyphosphates. Normally, these are added to the untreated water in order to exchange them with a carbonate group, thereby disrupting limescale nucleation.

One way of achieving this is by liquid dosing with freely soluble polyphosphates or by solubility-controlled dosing through contact with poorly soluble polyphosphates.

Freely soluble polyphosphates are mostly sodium salts of polyphosphates, poorly soluble polyphosphates accordingly being calcium or magnesium polyphosphate salts.

In the case of dosing in a water tank, for example in a water tank of a household appliance, a problem up to now has been the inability of the poorly soluble salt to release sufficient polyphosphate for protection against limescale, particularly of the water tank itself, i.e. of the surfaces thereof that come into contact with the water to be stored therein. Over the course of time, this results in undesirable and unsightly deposits forming on these surfaces too.

Moreover, it is not possible for the poorly soluble polyphosphate to be stored together with a weakly acidic ion exchanger, as is the arrangement, for example, when a filter cartridge serves as a filter bed; for example, a filter cartridge for a water tank of a household appliance, since the weakly acidic ion exchanger of the filter cartridge gives rise to ambient humidity levels of over 80% relative humidity in the airtight film packaging. Airtight packaging is in turn necessary to protect the ion exchanger from drying out.

However, the stable storage of poorly soluble polyphosphate is not possible if the relative humidity is greater than 50%. If poorly soluble polyphosphate and damp ion exchanger are packed together, the consequences of this are efflorescence and free water on the surface of the polyphosphate, which disperses within the film packaging, leaving behind white spots on the product.

The use of liquid polyphosphate is likewise problematic, since not only must the dosing process employed persist for three months, overdosing must not occur. Although release can be adjusted to a certain degree by minimizing the contact surface area and diffusion, this barely addresses the problem of storage (leakage and drying out) and that of overdosing on prolonged contact.

For dosing polyphosphates within mains-fitted water-treatment devices, especially decarbonization filters, there are likewise no easy technical solutions to the problems of adequate dosage, storage in a closed container at high relative humidity, and avoidance of overdosing.

The object underlying the invention is accordingly to provide improvements both in the storage stability for antiscaling agents containing polyphosphate and in the dosing of polyphosphate from such an antiscaling agent in water.

This object is achieved by the features of claims 1, 5, and 7. The dependent claims specify advantageous and expedient developments.

The invention accordingly relates to a solid dosing agent for dosing phosphate and/or polyphosphate in water. This is characterized by the provision of a water-insoluble anion exchanger that is at least partially loaded with orthophosphate and/or polyphosphate counterions.

By using an anion exchanger having polyphosphate counterions for dosing polyphosphate in water, the ionic bonding of polyphosphate ions on an anion exchanger allows long-lasting stable storage of the polyphosphate to be achieved.

Not only that, but this bonding of polyphosphate to an anion exchanger allows polyphosphate release to be kept within an upper limit through ion-exchange equilibria reactions. Below the equilibrium, particularly with untreated water, the rate of release is however high, with the result that sufficient polyphosphate can be released over a long period.

In a preferred embodiment, a basic anion exchanger, in particular a weakly basic anion exchanger, is provided.

In another preferred embodiment, an anion exchanger based on polystyrene is provided.

An anion exchanger based on polyacrylate may alternatively or additionally be provided.

The invention also relates to a process for producing a solid dosing agent for dosing phosphate and/or polyphosphate in water. This is characterized by the use of a liquid polyphosphate solution, in particular a sodium polyphosphate solution, as starting material for loading the water-soluble anion exchanger.

The anion exchanger may preferably be loaded with polyphosphate ions by first filtering the polyphosphate solution, in particular the sodium polyphosphate solution, through an acidic cation exchanger, preferably a strongly acidic cation exchanger, and then passing it through the anion exchanger in OH⁻/free base form.

The invention further relates to the use of a solid dosing agent for dosing phosphate and/or polyphosphate in water. This is characterized by it being used for stabilizing water hardness.

The anion exchanger having polyphosphate counterions is preferably used in a filter device, especially in a water filter device.

In a preferred use, the water filter device may be used in a water tank, especially in a water tank of a hot-beverages machine and/or of a household appliance.

In particular, the water filter device may be used to prevent deposits from forming on surfaces in the water tank that come into contact with the water.

The water filter device may, however, also be used as a mains-fitted water filter device.

In the stabilization of water hardness through the use of an anion exchanger having polyphosphate counterions for dosing polyphosphate in water, the ionic bonding of polyphosphate ions on an anion exchanger allows long-lasting stable storage of the polyphosphate to be achieved.

Not only that, but this bonding of polyphosphate to an anion exchanger allows polyphosphate release to be kept within an upper limit through ion-exchange equilibria reactions. Below the equilibrium, particularly with untreated water, the rate of release is however high, with the result that sufficient polyphosphate can be released over a long period.

By exchanging carbonate ions, for example those present in untreated water, with the polyphosphate ions, in particular ionically bonded polyphosphate ions, loaded onto the anion exchanger, the crystallization of calcium carbonate/limescale in the water can be stopped or at least disrupted. This means that the hardness present does not precipitate and does not result in deposits forming on surfaces that come into contact with the water.

Preference is given to using a basic anion exchanger, in particular a weakly basic anion exchanger. Weakly basic ion exchangers have the advantage that they have considerably higher capacity compared to strongly basic ion exchangers. This allows considerably more polyphosphate ions to be applied to the anion exchanger and/or means that loading with the same quantity of polyphosphate ions requires a considerably smaller proportion of anion exchanger than is the case with a strongly basic anion exchanger for example.

In one particular embodiment of the invention, a weakly basic polyacrylate-based anion exchanger is used. Polyacrylate-based anion exchangers exhibit more favorable nitrosamine release compared even to suitable polystyrene-based anion exchangers.

In one use, the anion exchanger having polyphosphate counterions may be used in a filter device, especially in a water filter device.

The water filter device may preferably be used in a water tank, especially in a water tank of a hot-beverages machine and/or of a household appliance.

The water filter device may be used here, for example, to prevent deposits from forming on surfaces in the water tank that come into contact with the water.

The water filter device, however, also be used as a mains-fitted water filter device.

In such uses too, the invention described herein provides a material that is storage stable and allows uniform dosing of polyphosphate.

In a process for producing an anion exchanger having polyphosphate counterions, the starting material used for the polyphosphate anion employed may be a liquid polyphosphate solution, in particular a sodium polyphosphate solution. Sodium polyphosphate solutions are liquid at high concentrations of up to approx. 30% by weight, which makes dosing with them simple and means that the storage thereof takes up less space.

In a preferred production process, the anion exchanger may be initially loaded with polyphosphate ions using the polyphosphate solution, in particular the sodium polyphosphate solution. The solution is then advantageously passed through an acidic cation exchanger, preferably a strongly acidic cation exchanger, for example filtered and then passed through the anion exchanger in OH⁻/free base form. In order to transfer the polyphosphate solution to the anion exchanger in high yield, this should advantageously be diluted with water before use to a concentration of preferably 0.5% to 5% by weight.

In summary, it can be noted that, in the process for stabilizing hardness, an anion exchanger having polyphosphate counterions is used for dosing polyphosphate in water.

For production, the initially liquid polyphosphate can be bonded ionically to a preferably weakly basic anion exchanger. This is because weakly basic anion exchangers have a considerably higher loading capacity by comparison with strongly basic ones. This allows the same loading capacity to be provided with a considerably smaller amount of anion exchanger by comparison with a strongly basic anion exchanger. There is also a corresponding reduction in the space required therefor and in the volume needed.

The exchanger treated in this way may be stored almost indefinitely both in the dry and wet states. Moreover, the release of polyphosphate in contact with water is kept within an upper limit through ion-exchange equilibria reactions with substances present in the water. Below the equilibrium with untreated water, the rate of release is however high, with the result that sufficient polyphosphate can be released over a long period.

Preference is given to using a weakly basic polystyrene-based anion exchanger as the anion exchanger.

Alternatively, a preferably weakly basic polyacrylate-based anion exchanger may be used.

The envisaged starting material for the polyphosphate anion used is a liquid polyphosphate solution, in particular a liquid sodium polyphosphate solution.

The anion exchanger is loaded with polyphosphate ions by first filtering the polyphosphate solution, in particular the sodium polyphosphate solution, through a preferably strongly acidic cation exchanger in H⁺ form and then passing it through the anion exchanger in OH⁻/free base form.

### WORKING EXAMPLE

The present invention is elucidated in more detail hereinbelow with reference to the included figures and the description that refers to them.

In the figures:

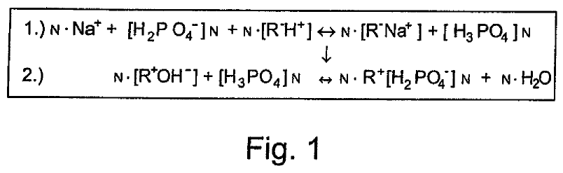

FIG. 1 shows the formulas for the production of a polyphosphate-loaded anion exchanger for dosing polyphosphate in water.

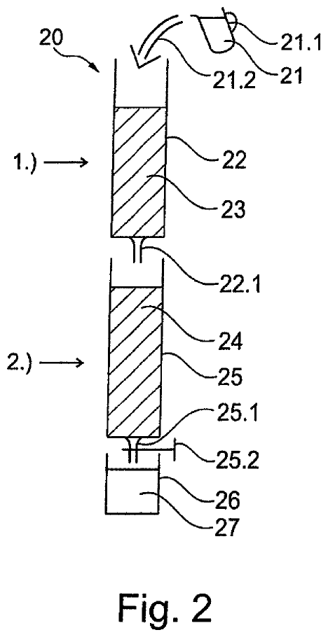

FIG. 2 shows an exemplary diagram of the steps in the production process for a polyphosphate-loaded anion exchanger for dosing polyphosphate in water and of the products and intermediates that are used and formed in the process.

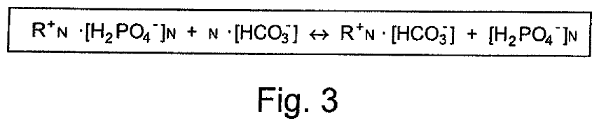

FIG. 3 shows the formulas for the use of a polyphosphate-loaded anion exchanger for dosing polyphosphate in water.

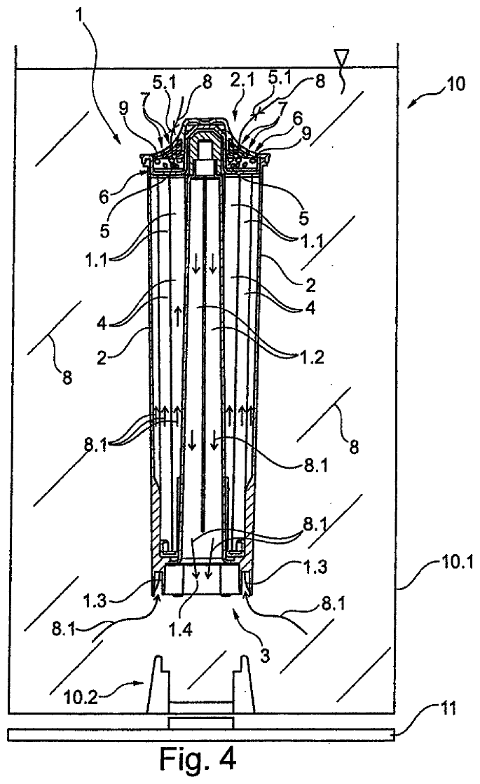

FIG. 4 shows an exemplary diagram, in longitudinal cross section, of a water filter cartridge containing an agent for preventing the formation of limescale in water, when used in a water tank likewise shown in longitudinal cross section.

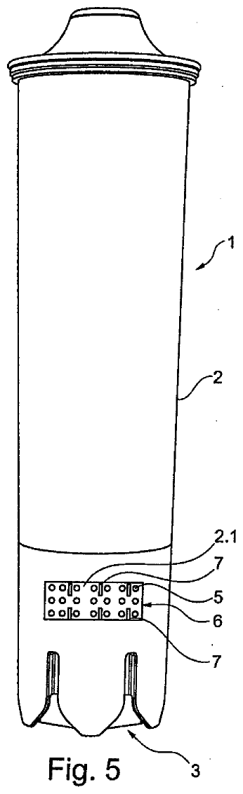

FIG. 5 shows an exemplary diagram, in front view, of an alternative embodiment to FIG. 4 comprising a water filter cartridge having a reservoir for an agent countering the formation of limescale.

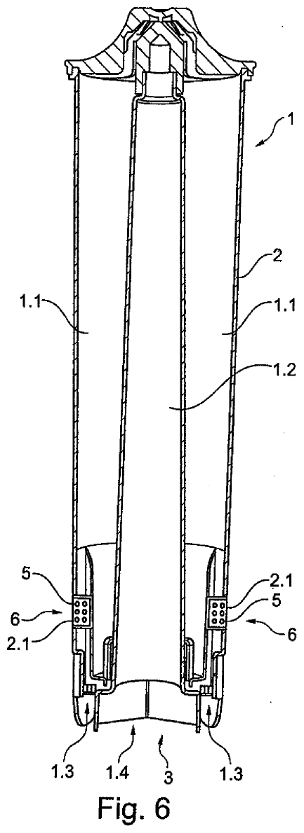

FIG. 6 shows an exemplary diagram, in sectional view, of the embodiment presented in FIG. 5.

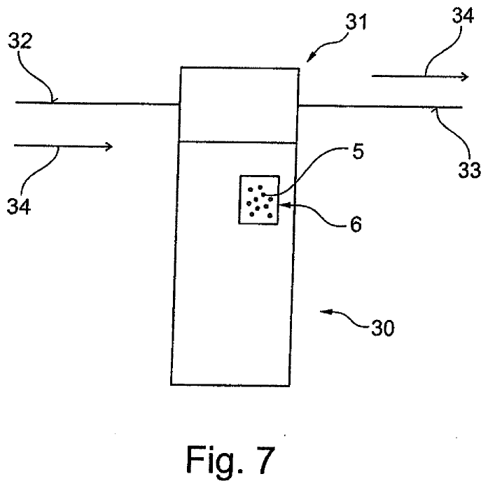

FIG. 7 shows an exemplary diagram, in longitudinal cross section, of a mains-fitted water filter cartridge containing an agent for preventing the formation of limescale in water.

### CONSTRUCTIONAL DESIGN

FIG. 1 shows formulas “1.)” and “2.)” for the production of a polyphosphate-loaded anion exchanger for dosing polyphosphate in water. In the figure:

### Na⁺: Sodium ion

[H₂PO₄⁻]_{N}: Polyphosphate ion having
chain length _{N} and _{N} negative charges
[H₃PO₄]_{N}: Polyphosphoric acid
R⁻: Strongly acidic cation exchanger
R⁺: At least weakly basic anion exchanger

### H⁺: Hydrogen ion

### OH⁻: Hydroxide ion

Step 1: Removal of Sodium

_{N}.Na⁺+[H₂PO₄⁻]_{N}+_{N}.[R⁻H⁺] [symbol] _{N}.[R⁻Na⁺]+[H₃PO₄]_{N}

Step 2: Bonding of Polyphosphate on Anion Exchanger

_{N}.[R⁺OH⁻]+[H₃PO₄]_{N} [symbol] _{N}. R⁺[H₂PO₄⁻]_{N}+_{N}.H₂O

FIG. 2 shows an assembly 20 for producing an anion exchanger loaded with polyphosphate 21 for dosing polyphosphate in water in accordance with formulas “1.)” and “2.)” shown in FIG. 1.

In process step “1.)”, the anion exchanger is loaded with polyphosphate ions by first filtering the sodium polyphosphate solution 21 through a preferably strongly acidic cation exchanger 23 and then passing it through the anion exchanger 24 in accordance with process step “2.)” The latter may be present, for example, in at least weakly basic OH⁻/free base form.

In the assembly 20 shown by way of example, the sodium polyphosphate solution 21 held in container 21.1 is passed in the direction of arrow 21.2 onto the strongly acidic ion exchanger granules 23 in H⁺ form in a container 22 in order to separate the polyphosphate from the sodium, and is then fed, via the outlet 22.1, onto the support material in container 25, which is in the form of anion exchanger granules 24, in order to load the latter with polyphosphate.

Residual demineralized water 27 is run off into a container 26 through the outlet 25.1, which is provided with a means of closure 25.2.

The polyphosphate that is now ionically bonded to the anion exchanger granules 24 has almost limitless storage stability and is stable under both dry and wet conditions.

FIG. 3 shows the formula for the release of polyphosphate from the anion exchanger loaded according to the process shown in FIG. 2, for dosing polyphosphate in water.

In the figure:
R⁺_{N}: Weakly basic anion exchanger
[H₂PO₄⁻]_{N}: Polyphosphate having chain length N and N negative charges
HCO₃⁻: Hydrogen carbonate

R⁺_{N}.[H₂PO₄⁻]_{N}+_{N}.[HCO₃⁻] [symbol] R⁺_{N}.[HCO₃⁻]+[H₂PO₄⁻]_{N}

The release of polyphosphate in contact with water is kept within an upper limit through ion-exchange equilibria reactions with substances present in the water. Below the equilibrium with untreated water, the rate of release is, by contrast, high. This allows sufficient release of polyphosphate over a long period.

This process for stabilizing hardness thus uses an anion exchanger having polyphosphate counterions for dosing polyphosphate in water. This is preferably a weakly basic polyacrylate-based anion exchanger. Alternatively, a weakly basic polystyrene-based anion exchanger may be used.

The starting material for the polyphosphate anion used is a liquid polyphosphate solution, in particular a sodium polyphosphate solution. Potassium polyphosphate solutions are also conceivable.

The anion exchanger is loaded with polyphosphate ions by first filtering the sodium polyphosphate solution through a preferably strongly acidic cation exchanger and then passing it through the anion exchanger in OH⁻/free base form.

FIG. 4 shows a water filter cartridge 1 containing an anion exchanger having polyphosphate counterions for dosing polyphosphate in water, when used in a water tank 10, the housing of which is numbered 10.1. For this, the filter-side tank connection element 3 is coupled to a tank-side filter connection element 10.2, preferably by means of a plug-in connection.

The water filter cartridge 1 comprises a housing 2, an inlet opening 1.3 and an outlet opening 1.4 for the inflow and outflow of the water 8 held in the water tank into the filter cartridge 1 and back out again. For use in, for example, a hot-beverages machine 11 connected downstream, this water 8 is treated by passage through a filter train 4. Such a filter train may be designed in the upflow chamber 1.1 and/or the downflow chamber 1.2. The arrows 8.1 indicate the direction of flow of the water during the withdrawal thereof from the water tank 10 when the filter cartridge 1 in the fully operational state is in operation as a filter.

The water filter cartridge 1 comprises, in addition to the filter train 4 and designed separately therefrom, a reservoir 6, preferably in the form of a storage tank for an antiscaling agent 5, in particular an agent countering the formation of limescale in the water tank, with contact openings 7 provided that connect the reservoir 6 with the water 8 held in the water tank 10.

The reservoir 6 may be positioned in the housing 2 of the water filter cartridge 1; in the illustrated case in a top unit 2.1 of the housing.

The agent 5 countering the formation of limescale in the water tank may include a weakly acidic cation exchanger and/or a hardness stabilizer and/or a poorly soluble polyphosphate, in particular one that is calcium-based.

The agent 5 countering the formation of limescale in the water tank may include a freely soluble polyphosphate that is sodium-based.

In addition, the agent 5 countering the formation of limescale in the water tank may include a weakly basic anion exchanger material, in particular a weakly basic anion exchanger material having polyphosphate ions as counterions.

And the weakly basic anion exchanger material may be provided as a stabilizing agent for the polyphosphate.

The arrows 8.1 indicate the inflow of the water 8 held in the water tank 10 into the agent 5 countering the formation of limescale in the water tank. It flows through the contact openings 7 into the reservoir for the agent 5. A casing 9 or the like is optionally also provided to additionally enclose the agent 5.

The arrows 5.1 indicate the water 8 held in the water tank 10 that has already been treated with the agent 5 countering the formation of limescale in the water tank. Because the treatment substances from the agent 5 are in higher concentration in the water 8 close to the agent 5 compared to water held elsewhere in the water tank but which has not yet come into contact with the agent 5, a concentration equilibrium develops that, over the course of the storage period, also effects treatment of the remaining water stored in the water tank and thereby, in accordance with the invention, prevents the formation of limescale on the surfaces coming into contact with the water.

An agent 5 countering the formation of limescale, in the form of a hardness stabilizer, may also additionally be provided in the area through which the water undergoing treatment passes in and/or around the water filter cartridge 1. For example in and/or around the area of water inflow into the filter cartridge. A reservoir 6 therefor may also be provided, for example, in the form of a space at least partially enclosed by a fabric, for example, an insert component such as a ring filled with the agent 5, or in the form of a filling, preferably at least outwardly secured with a means of preventing the contents from escaping, for example a casing or the like. As an example thereof, a reservoir 6 filled with an agent 5 is shown above the inlet opening 1.3 in FIG. 4.

FIG. 5 shows an exemplary diagram, in front view, of an alternative embodiment to FIG. 4 comprising a water filter cartridge 1 having a reservoir 6 for an agent 5 countering the formation of limescale. In this embodiment, a reservoir 6 for the agent 5 countering the formation of limescale may be positioned in and/or on the housing 2. Small circles are depicted for visualization of the preferably granular agent 5. The granules 5 may be held inside the reservoir 6 by means of a cover, for example corresponding to the top unit 2.1 in the design shown in FIG. 4. Here too, contact openings 7 may provide the water with access to the agent 5. The rectangular representation of the contact openings 7 is shown purely by way of example for easier differentiation in this visualization. They can also have other shapes and/or cross sections.

FIG. 6 shows a sectional view of the design for a water filter cartridge 1 shown in FIG. 5 that has, on opposite sides of the housing 2, reservoirs 6 for the agent 5 countering the formation of limescale. To simplify the illustration, contact openings 7 water with access to the agent 5 are not shown, but may be present. The remaining reference numbers correspond to the features of the water filter cartridge 1 presented in FIG. 1.

FIG. 7 shows a further use in which a mains-fitted water filter canister 30 contains an agent 5 countering the formation of limescale, which is preferably stored inside a reservoir 6. The mains-fitted water filter canister 30 is connected to a connection head 31 that is connected to an inflow line 32 and an outflow line 33 of a water line. Arrows 34 indicate the direction of flow of the water.

### LIST OF REFERENCE NUMBERS

1 Water filter cartridge
1.1 Upflow chamber
1.2 Downflow chamber
1.3 Inlet opening
1.4 Outlet opening
2 Housing
2.1 Top unit
3 Filter-side tank connection element
4 Filter train
5 Agent countering the formation of limescale
5.1 Water treated with the agent countering the formation of limescale
6 Reservoir
7 Contact openings
8 Water
8.1 Arrow
9 Casing or the like
10 Water tank
10.1 Housing
10.2 Tank-side filter connection element
11 Household appliance, in particular hot-beverages machine
20 Assembly
21 Polyphosphate
21.1 Container
21.2 Arrow
22 Container
22.1 Outlet
23 Cation exchanger
24 Anion exchanger
25 Container
25.1 Outlet
25.2 Means of closure
26 Container
27 Demineralized water
30 Mains-fitted water filter canister
31 Mains-fitted connection head for 30
32 Inflow line
33 Outflow line
34 Arrow

1. A solid dosing composition for dosing phosphate and/or polyphosphate in water comprising a water-insoluble anion exchanger containing orthophosphate and/or polyphosphate counterions.

2. The solid dosing composition for dosing phosphate and/or polyphosphate in water as claimed in claim 1 wherein the water-insoluble anion exchanger is a basic anion exchanger.

3. The solid dosing composition for dosing phosphate and/or polyphosphate in water as claimed in claim 1 wherein the water insoluble anion exchanger includes polystyrene.

4. The solid dosing composition for dosing phosphate and/or polyphosphate in water as claimed in claim 1 wherein the water-insoluble anion exchanger includes polyacrylate.

5. A process for producing a solid dosing composition for dosing phosphate and/or polyphosphate in water comprising forming a water-insoluble anion exchanger having orthophosphate and/or polyphosphate counterions by first using a liquid polyphosphate solution as starting material for loading water insoluble anion exchanger.

6. The process for producing a solid dosing composition for dosing phosphate and/or polyphosphate in water as claimed in claim 5 further comprising the step of first filtering the polyphosphate solution through an acidic cation exchanger and then passing it through the anion exchanger in OH⁻/free base form.

7. The use of the product of the process of claim 15 for stabilizing water hardness.

8. The use of the product of the process of claim 15 in a water filter device.

9. The use of the product of the process of claim 15 in a water tank of an appliance.

10. The use of the product of the process of claim 15 to prevent deposits from forming on surfaces in a water tank that come into contact with water.

11. The use of the product of the process of claim 15 in a water filter device for a mains-fitted water filter device.

12. The solid dosing composition for dosing phosphate or polyphosphate as claimed in claim 1 wherein the water-insoluble anion exchanger is a weakly basic anion exchanger.

13. The process for producing a solid dosing composition for dosing phosphate and/or polyphosphate in water of claim 6 wherein the liquid phosphate solution is a solution of sodium polyphosphate.

14. The process for producing a solid dosing composition for dosing phosphate and/or polyphosphate in water of claim 13 wherein said acidic cation exchanger is a strongly acidic cation exchanger.

15. The product of the process of claim 5.

16. The use of the product of the process of claim 15 in a water tank of a hot beverage machine.

17. The use of the product of the process of claim 15 in a household appliance.

18. A stable storable water-insoluble anion exchanger composition with a controlled polyphosphate release in water comprising a water insoluble anion resin, a phosphate or a polyphosphate and an orthophosphate and/or polyphate counterions.

19. The stable storable water-insoluble anion exchanger composition of claim 18 wherein the water insoluble anion resin is a polystyrene anion exchange resin.

20. The stable storable water-insoluble anion exchanger composition of claim 18 wherein the water-insoluble anion resin is a polyacrylate anion exchange resin.
